(19) United States
(12) Patent Application Publication
(10) Pub. No.: US 2023/0267597 A1
(43) Pub. Date: Aug. 24, 2023

(54) YARN INSPECTION SYSTEM AND SCREENING METHOD

(71) Applicant: ASAHI KASEI KABUSHIKI KAISHA, Tokyo (JP)

(72) Inventors: Hiroshi Tsukumo, Tokyo (JP); Shinichiro Tanaka, Tokyo (JP); Yoshinobu Fujimura, Tokyo (JP); Fuminori Murai, Tokyo (JP)

(73) Assignee: ASAHI KASEI KABUSHIKI KAISHA, Tokyo (JP)

(21) Appl. No.: 17/679,216

(22) Filed: Feb. 24, 2022

(51) Int. Cl. G06T 7/00; G06T 5/00; G01N 21/89; G01N 21/892

(52) U.S. Cl. CPC G06T 7/0006; G06T 5/001; G01N 21/8914; G01N 21/892; G06T 2207/30108; G01N 2021/8887

(57) ABSTRACT

An inspection system of a filament yarn, including: an irradiation means configured to irradiate the filament yarn with inspection light; a measurement means configured to measure with an area sensor a luminance level of a shade and a background of the filament yarn; an image processing means configured to obtain image information on the basis of information obtained from the area sensor; and a determination means configured to decide a type and a frequency of an error from the image information and determine an inspection result of the filament yarn on the basis of a threshold value according to the error is provided.

### FIELD

The present invention relates to an inspection system and an inspection method of a filament yarn, a screening apparatus and a screening method of an original yarn, and a weaving method of a filament yarn using the screened original yarn.

### BACKGROUND

A filament yarn is obtained by bundling multiple fiber monofilaments, each of which is obtained by spinning a raw material, such as glass, a synthetic resin, a natural resin, carbon, or metal. For example, a filament yarn is used for manufacturing various members, such as a laminated plate, a printed circuit board, a stent graft, a composite material, a reinforcing material, and a concrete crack inhibiting material. Among these, a glass filament yarn is known as an ingredient of a printed circuit board.

For example, a glass filament yarn is formed by bundling from several tens to several thousands of glass fiber monofilaments having a diameter of from several to several tens of micrometers, each of which is obtained by spinning molten glass, and the glass filament yarn is wound around a drum to be in a state called a cake first. Then, the glass filament yarn is unwound from the cake, and, by twisting the glass filament yarn, a glass yarn is obtained and shipped. The glass yarn is woven into cloth, opened and/or sized as necessary, combined and laminated with a matrix resin, such as an epoxy resin, and processed into a printed circuit board.

In addition, a product form of a single bobbin in a state where a glass yarn is wound around a bobbin, glass roving obtained by bundling and combining several tens of glass filament yarns, or a chopped strand obtained by cutting glass filament yarns into a size of from several to several tens of millimeters may be shipped. An original yarn can be supplied from a single bobbin to a weaving process as a warp yarn and/or a weft yarn. Glass roving is used as an ingredient of a glass fiber reinforced plastic (FRP, FRTP), and a chopped strand is used as a reinforcing material of a thermoplastic resin.

Since multiple fiber monofilaments come in contact with and rub against one another in a process of bundling the fiber monofilaments to form a filament yarn, a process of unwinding the filament yarn from a cake, a weaving process, or a processing process, the glass fiber monofilaments may be partially cut, or a fluff defect in which the cut glass fiber monofilaments are woven may occur. The fluff defect not only deteriorates the workability but also influences the quality of a final product. For example, in the case of using glass cloth obtained by weaving a glass filament yarn in a printed circuit board, when a fluff is present on the surface of the glass filament yarn, the flatness of the printed circuit board may be deteriorated, thereby causing a problem in forming copper foil. An inspection system and an inspection method of a fluff that can be generated on an ultrafine glass fiber monofilament as an ingredient of a high-density printed circuit board have been conventionally examined (for example, refer to PTL 1).

PTL 1 describes an inspection system of a glass filament yarn obtained by bundling multiple ultrafine glass fiber monofilaments having a diameter of more than 3 μm and 7 μm or less, including: an irradiation means configured to irradiate the moving glass filament yarn with inspection light; a measurement means configured to measure linearly a luminance level of a surface of the glass filament yam; an extraction means configured to extract a monofilament discharged from the glass filament yarn on the basis of the measured luminance level; an image processing means configured to convert an extraction result into an image of a luminance level of 256 gradations and binarize the image; and a determination means configured to determine that, in the binarized image, the monofilament is defective when the amount of the monofilament discharged is a predetermined threshold value or more, and further describes an inspection method of a glass filament yarn using the above-described inspection system.

### CITATION LIST

### Patent Literature

[PTL 1] Japanese Unexamined Patent Publication No. 2012-7248

### SUMMARY

### Technical Problem

However, the inspection system and the method described in PTL 1 have room for further improvement in inhibition and elimination of a fluff defect. In addition, the inspection system and the method using a line sensor described in PTL 1 still have room for examination regarding the yield and the stable mass production of woven products, and a detailed determination and an investigation into the cause of a fluff defect.

In view of the above-described problems, it is an object of the present invention to eliminate or inhibit a fluff defect during weaving of a filament yarn by using a specific inspection system or a specific inspection method.

### Solution to Problem

The present inventors have conducted diligent research. As a result, they have found that the above-described problems can be solved by carrying out a specific inspection and a specific screening at a stage of an original yarn prior to a weaving process to complete the present invention. The present disclosure includes the following aspects.

(1) An inspection system of a filament yarn, including: an irradiation means configured to irradiate the filament yarn with inspection light; a measurement means configured to measure with an area sensor a luminance level of a shade and a background of the filament yarn obtained by the irradiation with the inspection light by the irradiation means; an image processing means configured to obtain image information on the basis of information obtained from the area sensor; and a determination means configured to decide an error and a frequency of the error from the image information and determine an inspection result of the filament yarn on the basis of a threshold value according to the error.

(2) The inspection system according to item (1), in which, when the error includes a plurality of types of errors, the determination means determines the inspection result of the filament yarn on the basis of a threshold value series according to each error type.

(3) The inspection system according to item (1) or (2), in which, when the threshold value includes a plurality of threshold values, the determination means outputs a determination result of the image with the threshold values being divided into a first threshold value or less, from the first threshold value to a second threshold value, and the second threshold value or more.

(4) The inspection system according to item (3), in which, when the threshold value includes three or more threshold values, the determination means outputs a determination result of the image with the threshold values being divided into a first threshold value or less, from the first threshold value to a second threshold value, from the second threshold value to a third threshold value, and the third threshold value or more.

(5) The inspection system according to any one of items (1) to (4), in which the determination means decides the threshold value by combining the image information and a measurement result of a yarn diameter of the filament yarn.

(6) The inspection system according to any one of items (1) to (5), in which the image processing means carries out a correction of the image.

(7) The inspection system according to any one of items (1) to (6), in which the filament yarn is made of at least one selected from the group consisting of a glass fiber, an acrylic resin fiber, a fiber containing an acrylic resin and another synthetic resin, and a carbon fiber.

(8) The inspection system according to item (7), in which the filament yarn is made of the glass fiber.

(9) The inspection system according to any one of items (1) to (8), further including a control means configured to control the irradiation means, the measurement means, the image processing means, and the determination means.

(10) The inspection system according to any one of items (1) to (9), in which the determination means further determines acceptance or rejection of an original yarn of the filament yarn on the basis of the inspection result of the filament yarn.

(11) The inspection system according to any one of items (1) to (10), in which the filament yarn is composed of from 10 to 500 single yarns having a single yarn diameter of from 1 to 10 μm.

(12) The inspection system according to any one of items (1) to (11), which is used off-line.

(13) The inspection system according to any one of items (1) to (11), which is used in-line.

(14) An inspection method of a filament yarn, including: an irradiation process for irradiating the filament yarn with inspection light; a measurement process for measuring with an area sensor a luminance level of a shade and a background of the filament yarn obtained by the irradiation with the inspection light by the irradiation process; an image processing process for obtaining image information on the basis of information obtained from the area sensor; and a determination process for deciding an error and a frequency of the error from the image information and determining an inspection result of the filament yarn on the basis of a threshold value according to the error.

### Advantageous Effects of Invention

According to the present invention, by using a specific inspection system or a specific inspection method, a fluff defect during weaving of a filament yarn can be eliminated or inhibited, and therefore, the yield improvement, the stable mass production, the efficiency increase, and the quality increase of woven products can be achieved.

### BRIEF DESCRIPTION OF DRAWINGS

FIG. 1 is an oblique perspective view schematically illustrating an off-line inspection system according to an embodiment of the present invention.

FIG. 2 is an oblique view schematically illustrating an in-line inspection system according to the embodiment of the present invention.

FIG. 3 is a schematic configuration diagram of the inspection system according to the embodiment of the present invention.

FIG. 4 is a flowchart of an inspection method according to the embodiment of the present invention.

### DESCRIPTION OF EMBODIMENTS

Hereinafter, an embodiment of the present invention (hereinafter, referred to as “present embodiment”) will be described in detail with reference to the drawings. The present invention is not limited to the embodiment described below or the drawings, and can be modified in various ways without departing from the scope of the present invention.

Inspection System of Filament Yarn

Use of Inspection System

An inspection system of a filament yarn according to the present embodiment can be used for an inspection of a filament yarn, manufacturing of an original yarn, or processing of an original yarn, for example.

When the inspection system according to the present embodiment is used for the manufacturing of an original yarn, an original yarn of poor quality can be stopped or prevented from being shipped or continuously produced, and/or an investigation into the cause of the original yarn of poor quality is carried out early, thereby achieving the process control or the process improvement.

When the inspection system according to the present embodiment is used for the processing of an original yarn, an original yarn of poor quality can be prevented from being used, thereby achieving the quality control or the quality improvement in a processing process.

The inspection system of a filament yarn according to the present embodiment can be used off-line or in-line, for example.

Specifically, an in-line inspection system can be incorporated in a manufacturing process of an original yarn (for example, spinning bushing, sizing, winding, and twisting processes) or a processing process of an original yarn (for example, warping, weaving, and post-processing), so that the effects of the quality improvement of a fluff or the like in the manufacturing of an original yarn and the productivity improvement are exerted.

Specifically, an off-line inspection system is used for an inspection of a filament yarn itself or used prior to processing of an original yarn. By screening an original yarn of poor quality in advance, the original yarn of poor quality can be collected without being used, and the quality of a yarn can be controlled or improved.

Configuration of Inspection System

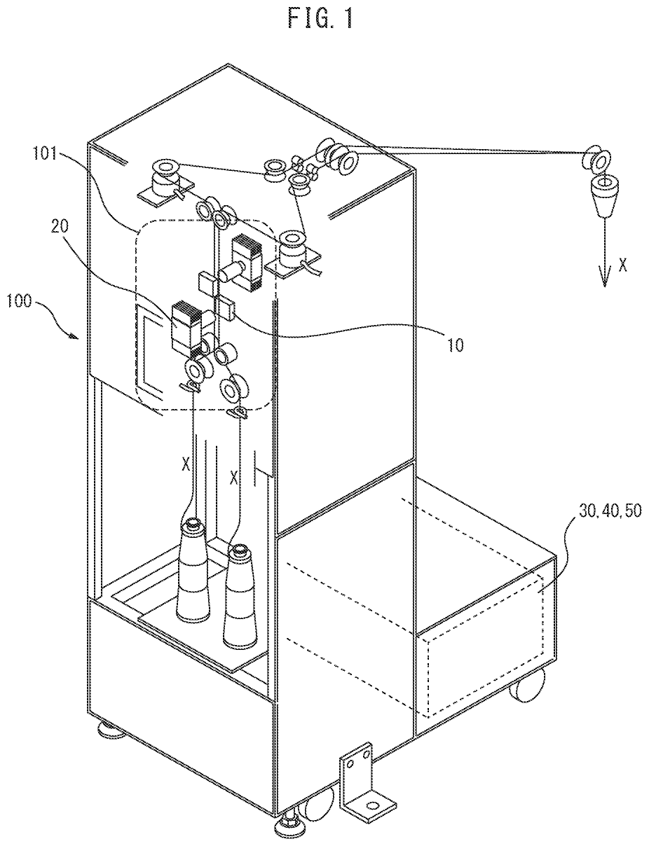

FIG. 1 is an oblique perspective view schematically illustrating off-line use of an inspection system of a filament yarn according to the present embodiment (hereinafter, simply referred to as “inspection system”) 100. The inspection system 100 can store a single or a plurality of bobbins of a filament yarn X as an object to be inspected, and can receive the filament yarn X unwound from the bobbin in an inspection unit 101 within the system via a stable delivery jig, such as a roller, a reel, or a guide.

The filament yarn X to be inspected is unwound from the bobbin placed in the inspection system 100 and introduced into the inspection unit 101. The filament X that has been inspected by the inspection system 100 can be wound by a jig, such as another bobbin, and furthermore, can be delivered to an outside line via a stable delivery jig. In addition, the filament yarn X that has been measured can be supplied to weaving, collected, reused, converted to another use, or discarded.

As illustrated in FIG. 1, the inspection system 100 includes the inspection unit 101 that is an optical system configured to irradiate the filament yarn X with light and measure a luminance level of a shade and a background of the filament yarn X in a two-dimensional region, and an arithmetic unit including a computer, an arithmetic processing unit, a monitor, and a memory unit for analyzing a measurement result. More specifically, the optical system includes an irradiation means 10 configured to irradiate the filament yarn X with inspection light, and a measurement means 20 configured to measure with an area sensor the luminance level of the shade and the background of the filament yarn X obtained by the irradiation with the inspection light by the irradiation means 10. The arithmetic unit includes an image processing means 30 configured to obtain image information on the basis of information obtained from the area sensor, a determination means 40 configured to decide an error and a frequency of the error from the image information and determine an inspection result of the filament X on the basis of a threshold value according to the error, and, as necessary, a control means 50 configured to control the irradiation means 10, the measurement means 20, the image processing means 30, and the determination means 40.

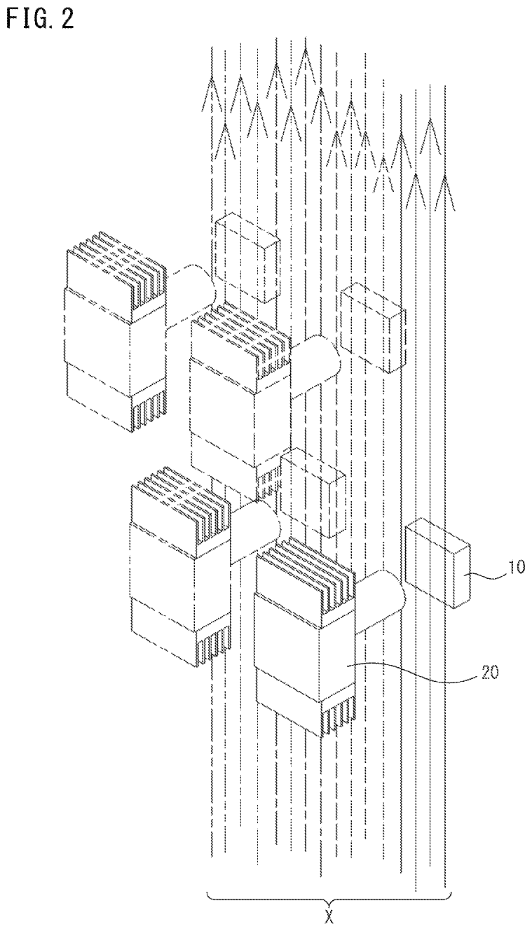

FIG. 2 is an oblique view schematically illustrating in-line use of the inspection system according to the present embodiment. The in-line inspection system includes the arithmetic unit including the image processing means 30, the determination means 40, and, as necessary, the control means 50 (these are all omitted in FIG. 2).

In FIG. 2, the arrows indicate a flow direction of the filament yarn X as an object to be inspected, and a yarn unwinding part (not illustrated) and a yarn winding part (not illustrated) can be arranged upstream of the line (lower side of FIG. 2) and downstream of the line (upper side of FIG. 2), respectively. In addition, the filament yarns X indicated by the solid arrows, the filament yarns X indicated by the dotted arrows, the filament yarns X indicated by the dashed-dotted arrows, and the filament yarns X indicated by the dashed-two dotted arrows can be inspected by a set of the irradiation means 10 and the measurement means 20 indicated by the solid line, a set of (10, 20) indicated by the dotted line, a set of (10, 20) indicated by the dashed-dotted line, and a set of (10, 20) indicated by the dashed-two dotted line, respectively, and determined by the arithmetic unit (not illustrated).

In the inspection system 100, the number of the sets of the irradiation means 10 and the measurement means 20 and the number of the filament yarns as an object to be inspected can be arbitrarily set. For example, the number of the sets of the irradiation means 10 and the measurement means 20 may be from 1 to 100, from 1 to 80, from 1 to 60, from 1 to 40, from 1 to 20, from 1 to 16, from 1 to 12, from 1 to 8, from 1 to 7, from 1 to 5, from 1 to 4, from 1 to 3, from 1 to 2, or 1, and the number of the filament yarns may be from 1 to 500, from 10 to 500, from 1 to 400, from 1 to 300, from 1 to 250, from 1 to 230, from 1 to 200, from 1 to 160, from 1 to 130, from 1 to 100, from 1 to 80, from 1 to 60, from 1 to 40, from 1 to 20, from 1 to 18, from 1 to 16, from 1 to 14, from 1 to 12, from 1 to 10, from 1 to 8, from 1 to 6, from 1 to 4, from 1 to 3, from 1 to 2, or 1. For example, in FIG. 1, two filament yarns X are inspected by two sets of the irradiation means 10 and the measurement means 20. In FIG. 2, four filament yarns X are inspected by one set of the irradiation means 10 and the measurement means 20, and 16 filament yarns X in total are inspected by four sets of (10, 20) in total.

For example, the filament yarn X may be made of at least one selected from the group consisting of a glass fiber, an acrylic resin fiber, a fiber containing an acrylic resin and another synthetic resin, and a carbon fiber. Among these, from the viewpoint of an investigation into the cause of a fluff defect of a woven product and a reduction in a fluff defect, the filament yarn to be inspected is preferably made of the glass fiber.

The filament yarn may be composed of multiple single yarns. From the viewpoint of the improvement of the determination accuracy by the arithmetic unit, a single yarn diameter is preferably from 1 to 10 μm, and more preferably from 3 to 7 μm. From the same viewpoint, the filament yarn is preferably composed of from 10 to 500 single yarns having the above-described single yarn diameter.

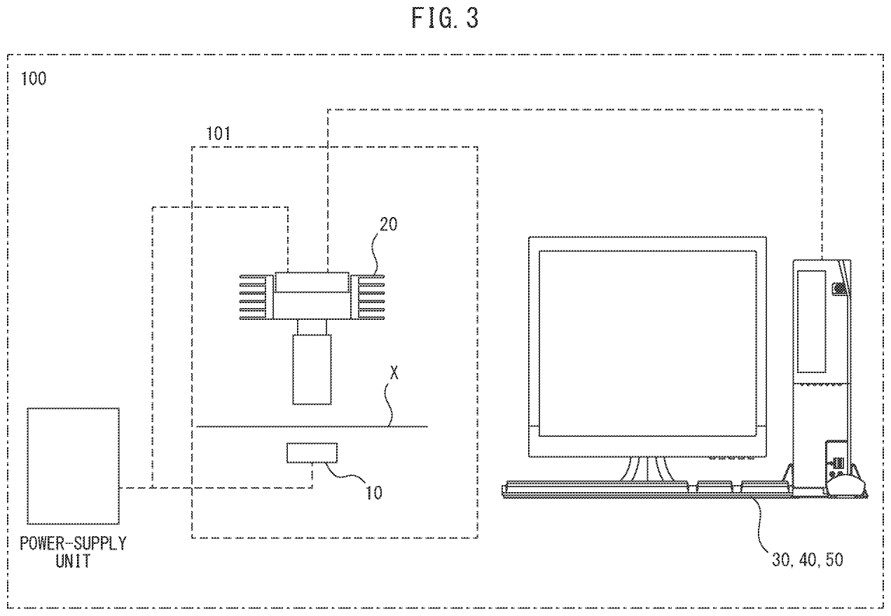

FIG. 3 is a schematic configuration diagram illustrating the inspection system 100. The inspection system 100 includes: the irradiation means 10 configured to irradiate the filament yarn X with inspection light; the measurement means 20 configured to measure with an area sensor a luminance level of a shade and a background of the filament yarn X; the image processing means 30 configured to obtain image information on the basis of information obtained from the area sensor; and the determination means 40 configured to decide an error and a frequency thereof from the obtained image information and determine an inspection result of the filament yarn X on the basis of a threshold value according to the error. The inspection system 100 may further include, as necessary, the control means 50 configured to control the irradiation means 10, the measurement means 20, the image processing means 30, and the determination means 40.

The inspection unit 101 includes, as components, the irradiation means 10 configured to irradiate the moving filament yarn X with light and the measurement means 20 configured to measure with an area sensor a luminance level of a shade and a background of the filament yarn X. The inspection unit 101 may include, as necessary, a roller, a guide, a reel, or the like as a stable delivery jig for making the filament yarn X move stably.

Irradiation Means

As illustrated in FIG. 1 to FIG. 3, the irradiation means 10 is formed as a single or a plurality of light sources configured to irradiate the moving filament yarn X with light. Although two light sources, four light sources, and one light source are illustrated in FIG. 1, FIG. 2, and FIG. 3, respectively, three light sources or five or more light sources may be used as long as a two-dimensional image of a luminance level can be measured by the measurement means 20. For example, a LED, a halogen lamp, or the like may be used as the light source, and among these, a LED is preferable. The irradiation means 10 is preferably configured to emit planar light so as to work with the measurement means 20, preferably includes a strobe lamp capable of being synchronized with the measurement means 20 so as to image an object to be inspected moving at high speed without shake, and/or preferably has a high directivity so as to be able to recognize even a thin fiber. A lamp to be used preferably has an output voltage of 24 V or more, and more preferably has an output voltage of 40 V or more.

Measurement Means

As illustrated in FIG. 1 to FIG. 3, the measurement means 20 is formed as a camera including an area sensor configured to measure a luminance level of a shade and a background of the filament yarn X in a two-dimensional region in response to the irradiation light. The number of the cameras can be determined according to the number of the light sources. Since the area sensor included in the camera is configured to measure a luminance level of a shade generated when the filament yarn X blocks the irradiation light and a background, in the present embodiment, a region where an irradiated range of the light source and an image receiving range of the area sensor overlap two-dimensionally is an area to be inspected of the filament yarn X. In the present embodiment, a direct area measurement by the area sensor can make a criterion for a defect easy to be set, improve the inspection accuracy of a defect, and reduce the influence of misregistration of the filament yarn X compared to a conventional inspection by a line sensor or conventional conversion into two-dimensional data by layering one-dimensional data.

At least one light source and at least one camera may be arranged to be deviated in terms of the optical axis as long as all objects to be measured are measured by the area sensor under the same positional conditions. From the viewpoint that the filament yarn X is accurately measured in the area to be inspected, at least one light source and at least one camera are preferably arranged to be opposed to each other with the filament yarn X sandwiched therebetween. From the viewpoint of the measurement accuracy in the area to be inspected, the filament yarn X is preferably delivered to the area to be inspected at a rate of from 80 to 1500 m/min and continuously and uninterruptedly imaged every imaging range in the whole length direction.

The area sensor may include a CMOS image sensor, and thus, can have a resolution of 5 μm or less per pixel and conduct an area measurement at a size of 15 mm by 20 mm per one measurement.

From the viewpoint of the irradiation accuracy and the measurement accuracy, as illustrated in FIG. 1 and FIG. 3, the irradiation means 10, the measurement means 20, the stable delivery jig, and the like are preferably placed in the inspection unit 101.

Data regarding the luminance level of the shade and the background of the filament yarn X measured by the area sensor is delivered to the arithmetic unit. In the arithmetic unit, image processing, analyzing, determining, saving, machine learning, and the like of the data regarding the luminance level are automatically carried out. The arithmetic unit can be achieved by, for example, a general-purpose personal computer, a large-scale computer, an arithmetic processing unit, a GPU, a monitor, a memory, image processing software, an image processing application, and artificial intelligence. The arithmetic unit includes the image processing means 30 configured to obtain an image from the area sensor, and the determination means 40 configured to decide an error and a frequency thereof from the obtained image, store a threshold value in a memory in accordance with the error, and determine an inspection result of the filament yarn X on the basis of the stored threshold value. The inspection system 100 or the arithmetic unit thereof may further include, as necessary, the control means 50 configured to control the irradiation means 10, the measurement means 20, the image processing means 30, and the determination means 40.

Image Processing Means

The image processing means 30 obtains the data regarding the luminance level of the shade and the background of the filament yarn X measured by the area sensor as a two-dimensional image. For example, the obtained image can be processed at 12-megapixels and a rate of 68 images per sec. The size of the obtained image can be set in advance within a range of the area to be inspected and can be enlarged or reduced. From the viewpoint of increasing the efficiency and the speed of the processing, making a criterion for a defect easy to be set, and improving the inspection accuracy of a defect, the image processing means 30 preferably carries out a correction of the obtained image. A specific example of the correction of the image will be described below.

In the image processing involving the correction, for example, (1) setting of inspection region and image reduction, (2) shading correction, (3) filtering, and (4) noise removal are carried out in this order.

In (1), by limiting the position of (the shade of) the filament yarn X and a periphery thereof as an inspection region, a processing load is reduced, the efficiency of the image processing is increased, the imaging is reduced as necessary, and increasing speed of the processing and noise inhibition are achieved.

Since a peripheral image tends to be darkened due to the characteristics of a camera 2 lens, a difference from a defective part of the yarn cannot be detected, and both images sometimes cannot be distinguished by mere binarization. In contrast, in (2), for the detection of a strand, the background of the object to be measured is corrected by the image processing, the luminance of the image of the fiber (yarn) and the luminance of the peripheral image are aligned, and the influence of a light quantity difference between both images is inhibited or eliminated.

In (3), when a defect of the object to be measured is detected, by smoothing the obtained image by, for example, the Gaussian filtering, noise is reduced while maintaining a contrast of the image of the defective part of the yarn. A load to be increased by the filtering of (3) can be reduced or distributed by hardware augmentation.

In (4), binarization of the image is carried out, and a binarization result using at least two of a relatively high threshold value and a relatively low threshold value is combined at the time, so that noise is removed from the image to obtain an optimized image. In the obtained image, a part of the detection result of the defect is sometimes disconnected. Dots in the region are extracted by thinning processing and neighborhood dots are connected, so that the disconnection is connected.

Determination Means

The determination means 40 automatically carries out a decision of an error and a frequency thereof from the obtained image, saving and accumulating of an output example, storing of a threshold value according to the error, a determination of an inspection result of the filament yarn X based on the stored threshold value, and the like. More specifically, the determination means 40 is configured to decide an error and a frequency thereof from the obtained image, store a threshold value in a memory in accordance with the error, and automatically determine an inspection result of the filament yarn X on the basis of the stored threshold value.

The error causes a fluff defect and varies depending on, for example, the use, the raw material, the size, and the required quality of the filament yarn to be inspected or the required quality of a final product. The threshold value may be decided by machine learning of the determination means 40 on the basis of a frequency of the error, or an operator of the inspection system 100 may appropriately set the threshold value and input the threshold value into a memory.

When the error includes a plurality of types of errors, the determination means 40 preferably stores a threshold value series in a memory for each error type, invokes the stored threshold value series according to each error type, and automatically determines an inspection result of the filament yarn X on the basis of the invoked threshold value series. The error type can be decided according to the raw material, the appearance, or the size of the filament yarn or an original yarn that is the object to be measured, and influences a degree of a fluff defect or the accuracy and the stability of weaving. Examples of the error type include, but not limited to, appearance errors, such as Cut, Loose, and Split, and yarn diameter errors, such as a maximum diameter, a minimum diameter, a difference between the maximum diameter and the minimum diameter (R), a yarn diameter distribution (for example, skewness and kurtosis), a yarn diameter standard deviation, and an average diameter. Among these, from the viewpoint of the determination accuracy, a determination based on an appearance error, or a determination based on a combination of an appearance error and a yarn diameter error is preferable.

When the threshold value of the frequency of the error decided from the obtained image includes a plurality of threshold values or there is a plurality of inflection points in a distribution graph of the frequency of the error, the determination means 40 preferably automatically outputs a determination result of the obtained image with the threshold values being divided into a first threshold value or less, from the first threshold value to a second threshold value, and the second threshold value or more. For example, when the threshold value includes three or more threshold values, the determination means 40 can automatically output a determination result of the obtained image with the threshold values being divided into a first threshold value or less, from the first threshold value to a second threshold value, from the second threshold value to a third threshold value, and the third threshold value or more.

In the present embodiment, the number of the threshold values and the threshold value to be an acceptance or rejection criterion may be decided according to the raw material of the object to be measured, the distinction between a warp yarn and a weft yarn, or the error type. For example, in the case of the error type “Cut” of a glass filament yarn as a weft yarn, one threshold value tends to be an acceptance or rejection criterion value directly. In the case of the error type “Loose” of a glass filament yarn as a weft yarn, three threshold values tend to be decided, automatic output of a first threshold value or less (Without Loose), from the first threshold value to a second threshold value (Loose Standard “Small (S)”), and from the second threshold value to a third threshold value (Loose Standard “Medium (M)”) may be acceptance, and automatic output of the third threshold value or more (Loose Standard “Large (L)”) may be rejection. In addition, the threshold value of the error type “Split” of a glass filament yarn tends to be set more in an inspection of a warp yarn than that of a weft yarn.

From the viewpoint of the determination accuracy, the determination means 40 preferably decides the threshold value by combining the obtained image information and a measurement result of a yarn diameter of the filament yarn X. Information regarding the yarn diameter of the filament yarn X, for example, a maximum diameter, a minimum diameter, a difference between the maximum diameter and the minimum diameter (R), a yarn diameter distribution (for example, skewness and kurtosis), a yarn diameter standard deviation, and an average diameter, can be decided from the obtained two-dimensional image including the data regarding the luminance level of the shade and the background of the filament yarn X.

The filament yarn X which has been automatically determined that the inspection result of the filament yarn based on the threshold value is acceptance by the determination means 40 can be supplied to another line or a post-process, for example, a weaving process. In addition, the filament yarn X which has been automatically determined to be rejection for specific use can be collected, returned, or converted to another use.

Preferably, the determination means 40 further determines acceptance or rejection of an original yarn of the filament yarn to be inspected and determines acceptance or rejection of an original yarn in a single bobbin on the basis of the inspection result of the filament yarn X determined as described above. For example, the original yarn or the single bobbin which has been automatically determined to be rejection for specific use can be collected, returned, or converted to another use. In a weaving process, a glass yarn may be used as a warp yarn even when being a rejected product as a weft yarn, and vice versa.

Control Means

The control means 50 automatically controls the irradiation means 10, the measurement means 20, the image processing means 30, and the determination means 40, and can be conducted by, for example, an automatic arithmetic processing unit, a general-purpose personal computer, a large-scale computer, a memory, and artificial intelligence. The control means 50 is included in a computer that controls the arithmetic unit, arranged as an individual computer, or placed as an external server or cloud, and thus, can exchange data with the arithmetic unit by wire or wirelessly.

Inspection Method of Filament Yarn

Summary of Inspection Method

An inspection method of a filament yarn of the present invention is carried out by using the inspection system including the irradiation means, the measurement means, the image processing means, and the determination means described above.

More specifically, in the inspection method of a filament yarn, the following processes: an irradiation process for irradiating the filament yarn with inspection light; a measurement process for measuring with an area sensor a luminance level of a shade and a background of the filament yarn obtained by the irradiation with the inspection light by the irradiation process; an image processing process for obtaining image information on the basis of information obtained from the area sensor; and a determination process for deciding an error and a frequency of the error from the image information and determining an inspection result of the filament yarn on the basis of a threshold value according to the error are conducted.

Flowchart of Inspection Method

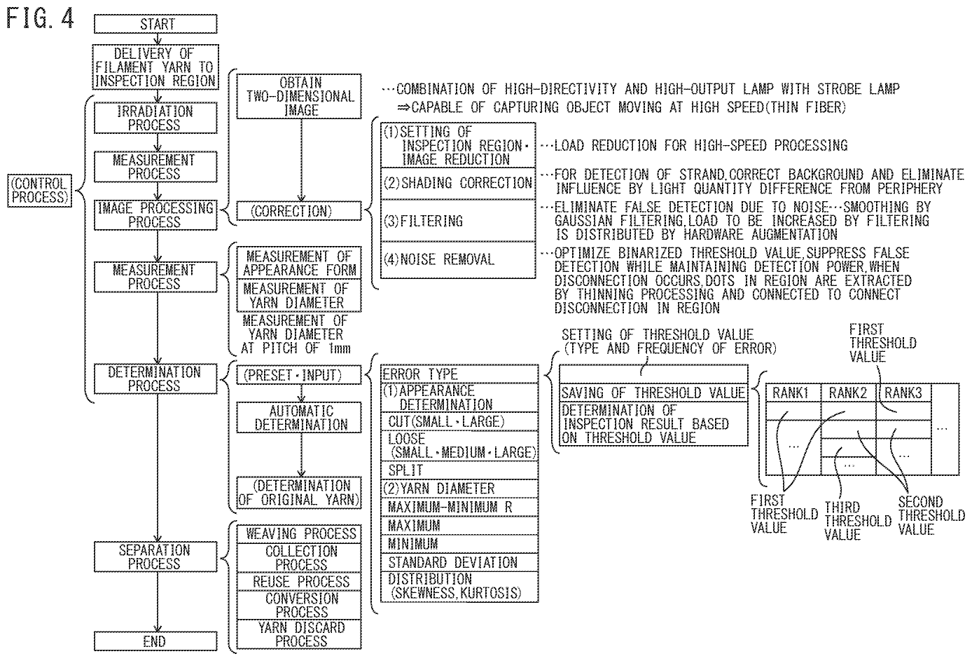

FIG. 4 illustrates a flowchart of the inspection method of a filament yarn according to the embodiment of the present invention. Each process of the inspection method can be carried out along FIG. 4. An arbitrary process is put in parentheses in FIG. 4 and can be carried out as necessary.

According to the inspection method of the present invention, by carrying out an inspection and screening of a filament yarn or an original yarn thereof at a stage prior to weaving, a fluff defect during the weaving of the filament yarn can be eliminated or inhibited, and therefore, the yield improvement and the stable mass production of woven products can be achieved.

### EXAMPLES

An inspection of a glass filament yarn actually using the inspection system 100 according to the present invention will be illustrated below.

### Example 1

Object to Be Inspected

Three bobbins around which each of four types of glass filament yarns (manufactured by AGY, LCD1020, LCD510, ECBC3750, ECBC3000) are wound, i.e., 12 bobbins in total, were prepared.
LCD1020 filament yarn (5 μm×100)
LCD510 filament yarn (5 μm x 200)
ECBC3750 filament yarn (4 μm x 40)
ECBC3000 filament yarn (4 μm x 50)

System Configuration

(a) One inspection system 100 having an appearance as illustrated in FIG. 1 was prepared.

(b) As illustrated in FIG. 1, as the light source of the irradiation means 10, two high-directivity type surface lamps “TH2-43X35-PW” manufactured by CCS Inc. were used.

(c) As illustrated in FIG. 1, as the camera of the measurement means 20, two cameras “boost boA4112-68 cm” manufactured by Basler with a CMOS sensor manufactured by Sony Corporation were used.

(d) The arithmetic unit (30, 40, 50) includes a personal computer and a monitor, and is connected to the measurement means 20 by wire or wirelessly.

Inspection

The bobbin around which the above prepared glass filament yarn is wound was set in the inspection system 100 and unwound at 1200 m/min, and the form imaging and the yarn diameter measurement of the filament yarn were carried out with the area sensor of the measurement means 20.

An image was captured in the arithmetic unit from the area sensor, (1) setting of inspection region and image reduction, (2) shading correction, (3) filtering, and (4) noise removal were carried out in this order, and corrected image data was supplied to the determination process. The determination means automatically outputs, on the basis of a criterion as a weft yarn for glass cloth, (i) two threshold values of “Cut”, three threshold values of “Loose”, and one threshold value of “Split” as the error types of a result of the appearance form and (ii) “Average”, “max”, “min”, “above first threshold value”, “above second threshold value”, “distribution (standard deviation, kurtosis, skewness)” as the error types of a result of the yarn diameter, respectively, and stores them in a memory.

Result

For each of the three bobbins around which each of four types of glass filament yarns (manufactured by AGY, LCD1020, LCD510, ECBC3750, ECBC3000) are wound, i.e., for each of the 12 bobbins in total, the determination result, the determination of a defect, and the result when cloth is actually produced using the original yarn of the present inspection and the residual yarn on the bobbin are shown in Table 1 to Table 4.

Inspection Length: 400 m (shoot 20 k images)

(Note: shown with average value of 50 bobbins)

TABLE 1
LCD1020

| | Yarn Diameter | | | | | Distribution | | | Appearance | | | | | | Deter- | |
|---|---|---|---|---|---|---|---|---|---|---|---|---|---|---|---|---|
| | | | | 300 < | 500 < | | | skew- | Cut | | Loose | | | | mination | Fluff |
| | average | max | min | x < 500 | x | σ | kurtosis | ness | Hi | Low | L | M | S | Split | Result | Formation |
| Sample 1 | 114.2 | 1585 | 40 | 0.13% | 0.12% | 32.1 | 2.4 | 67.1 | 7 | 7 | 0 | 6 | 391 | 10 | D | Formed |
| Sample 2 | 125.2 | 2130 | 40 | 0.07% | 0.06% | 35.6 | 3.7 | 162 | 3 | 2 | 0 | 3 | 759 | 7 | C | Slightly |
| | | | | | | | | | | | | | | | | Formed |
| Sample 3 | 127.9 | 350 | 35 | 0.03% | 0.00% | 35 | 0.6 | 0.2 | 0 | 0 | 0 | 0 | 161 | 0 | A | Not Formed |

TABLE 2
LCD510

| | Yarn Diameter | | | | | | | | Appearance | | | | | | Deter- | |
|---|---|---|---|---|---|---|---|---|---|---|---|---|---|---|---|---|
| | | | | 400 < | 500 < | Distribution | | | Cut | | Loose | | | | mination | Fluff |
| | average | max | min | x < 500 | x | σ | kurtosis | skewness | Hi | Low | L | M | S | Split | Result | Formation |
| Sample 1 | 200.4 | 1400 | 55 | 76.98% | 0.32% | 50.5 | 1 | 8.1 | 28 | 5 | 0 | 7 | 329 | 20 | D | Formed |
| Sample 2 | 205.2 | 1405 | 50 | 103.78% | 0.14% | 53 | 0.9 | 6.5 | 7 | 2 | 0 | 1 | 356 | 19 | C | Slightly Formed |
| Sample 3 | 205.8 | 480 | 55 | 90.92% | 0.00% | 49.7 | 0.6 | 0.6 | 0 | 0 | 0 | 2 | 222 | 0 | A | Not Formed |

TABLE 3
ECBC3750

| | Yarn Diameter | | | | | | | | Appearance | | | | | | Deter- | |
|---|---|---|---|---|---|---|---|---|---|---|---|---|---|---|---|---|
| | | | | 200 < | 500 < | Distribution | | | Cut | | Loose | | | | mination | Fluff |
| | average | max | min | x < 500 | x | σ | kurtosis | skewness | Hi | Low | L | M | S | Split | Result | Formation |
| Sample 1 | 85.4 | 1430 | 25 | 0.08% | 0.07% | 40.6 | 2.1 | 58.2 | 11 | 23 | 0 | 6 | 336 | 5 | D | Formed |
| Sample 2 | 82.4 | 465 | 25 | 0.03% | 0.00% | 41.2 | 1 | 0.8 | 0 | 1 | 0 | 2 | 256 | 4 | B | Not Formed |
| Sample 3 | 80.2 | 220 | 20 | 0.02% | 0.00% | 41.8 | 0.8 | 0.4 | 0 | 0 | 0 | 3 | 217 | 0 | A | Not Formed |

TABLE 4
ECBC3000

| | Yarn Diameter | | | | | | | | Appearance | | | | | | Deter- | |
|---|---|---|---|---|---|---|---|---|---|---|---|---|---|---|---|---|
| | | | | 200 < | 500 < | Distribution | | | Cut | | Loose | | | | mination | Fluff |
| | average | max | min | x < 500 | x | σ | kurtosis | skewness | Hi | Low | L | M | S | Split | Result | Formation |
| Sample 1 | 89.3 | 1205 | 30 | 0.09% | 0.06% | 38.1 | 2.2 | 55.3 | 12 | 18 | 0 | 8 | 408 | 4 | D | Formed |
| Sample 2 | 93.6 | 280 | 30 | 0.03% | 0.00% | 34.2 | 0.9 | 0.8 | 0 | 0 | 0 | 4 | 238 | 4 | A | Not Formed |
| Sample 3 | 92.8 | 250 | 25 | 0.03% | 0.00% | 37 | 0.7 | 0.6 | 0 | 0 | 0 | 2 | 263 | 0 | A | Not Formed |

### Example 2

For 216 glass filament yarns (manufactured by AGY, LCD1020), the accuracy comparison of fluff fitting ratios (fluff formation was predicted and actually fluffing occurred) was made by A) expectation from appearance inspection by person, B) only yarn diameter determination, C) only appearance form determination of the present invention, and D) appearance form determination of the present invention and yarn diameter determination. The result is shown in Table 5. In addition, the following accuracy comparison method was adopted and is arranged in Table 6.

TABLE 5

| | | | | | | | | D) Appearance Form | |
|---|---|---|---|---|---|---|---|---|---|
| | | | | B) Yarn | | C) Appearance | | Determination + | |
| | | A) Appearance | | Diameter | | Form | | Yarn Diameter | |
| | | Inspection | | Determination | | Determination | | Determination | |
| | | Prediction | | Prediction | | Prediction | | Prediction | |
| | | With | With No | With | With No | With | With No | With | With No |
| | | Fluff | Fluff | Fluff | Fluff | Fluff | Fluff | Fluff | Fluff |
| Actuality | With Fluff | 2 | 11 | 7 | 7 | 13 | 3 | 13 | 0 |
| | With No Fluff | 8 | 195 | 11 | 191 | 5 | 195 | 1 | 202 |

| | | | | |
|---|---|---|---|---|
| Precision | 0.2000 | 0.3889 | 0.7222 | 0.9286 |
| Recall | 0.1538 | 0.5000 | 0.8125 | 1.0000 |
| Accuracy | 0.9120 | 0.9167 | 0.9630 | 0.9954 |
| F-measure | 0.1739 | 0.4375 | 0.7647 | 0.9630 |

TABLE 6
Example of Accuracy Comparison Method

Prediction

| | | With Fluff | With No Fluff |
|---|---|---|---|
| Actuality | With Fluff | X (TP) | X (FN) |
| | With No Fluff | X (FP) | X (TN) |

Types of Fluff Fitting Ratios

A. Precision=TP/(TP+FP)

B. Recall=TP/(TP+FN)

C. Accuracy=(TP+TN)/(TP+FP+FN+TN)

D. F-measure=2×A×B/(A+B)

The image data captured in the personal computer and the data after the image processing were all saved and utilized for machine learning, an investigation into the cause of a fluff defect of glass cloth, and an accurate determination of a defect.

Table 1 to Table 6 indicate that the presence or absence of fluff formation of a filament yarn can be predicted with a high degree of accuracy by using the inspection system and the inspection method of a filament yarn according to the present invention.

### INDUSTRIAL APPLICABILITY

The inspection system and the inspection method according to the present invention can be used for an inspection of a filament yarn or an original yarn thereof used for manufacturing various members, such as a laminated plate, a printed circuit board, a stent graft, a composite material, a reinforcing material, and a concrete crack inhibiting material. In addition, the inspection system and the inspection method according to the present invention can be used for an inspection of a defect in not only a glass filament yarn but also a fiber other than a glass fiber (for example, a synthetic fiber, a natural fiber, a metal fiber). High-quality products can be provided to customers by screening in advance and not using a filament yarn of poor quality, so that the industrial utilization is extremely high.

### REFERENCE SIGNS LIST

100 Inspection system
101 Inspection unit
10 Irradiation means
20 Measurement means
30 Image processing means
40 Determination means
50 Control means
X Filament yarn

1. An inspection system of a filament yarn, comprising:
an irradiation means configured to irradiate the filament yarn with inspection light;
a measurement means configured to measure with an area sensor a luminance level of a shade and a background of the filament yarn obtained by the irradiation with the inspection light by the irradiation means;
an image processing means configured to obtain image information on the basis of information obtained from the area sensor; and
a determination means configured to decide an error and a frequency of the error from the image information and determine an inspection result of the filament yarn on the basis of a threshold value according to the error.

2. The inspection system according to claim 1, wherein, when the error includes a plurality of types of errors, the determination means determines the inspection result of the filament yarn on the basis of a threshold value series according to each error type.

3. The inspection system according to claim 1, wherein, when the threshold value includes a plurality of threshold values, the determination means outputs a determination result of the image with the threshold values being divided into a first threshold value or less, from the first threshold value to a second threshold value, and the second threshold value or more.

4. The inspection system according to claim 3, wherein, when the threshold value includes three or more threshold values, the determination means outputs a determination result of the image with the threshold values being divided into a first threshold value or less, from the first threshold value to a second threshold value, from the second threshold value to a third threshold value, and the third threshold value or more.

5. The inspection system according to claim 1, wherein the determination means decides the threshold value by combining the image information and a measurement result of a yarn diameter of the filament yarn.

6. The inspection system according to claim 1, wherein the image processing means carries out a correction of the image.

7. The inspection system according to claim 1, wherein the filament yarn is made of at least one selected from the group consisting of a glass fiber, an acrylic resin fiber, a fiber containing an acrylic resin and another synthetic resin, and a carbon fiber.

8. The inspection system according to claim 7, wherein the filament yarn is made of the glass fiber.

9. The inspection system according to claim 1, further comprising a control means configured to control the irradiation means, the measurement means, the image processing means, and the determination means.

10. The inspection system according to claim 1, wherein the determination means further determines acceptance or rejection of an original yarn of the filament yarn on the basis of the inspection result of the filament yarn.

11. The inspection system according to claim 1, wherein the filament yarn is composed of from 10 to 500 single yarns having a single yarn diameter of from 1 to 10 μm.

12. The inspection system according to claim 1, which is used off-line.

13. The inspection system according to claim 1, which is used in-line.

14. An inspection method of a filament yarn, comprising:
an irradiation process for irradiating the filament yarn with inspection light;
a measurement process for measuring with an area sensor a luminance level of a shade and a background of the filament yarn obtained by the irradiation with the inspection light by the irradiation process;
an image processing process for obtaining image information on the basis of information obtained from the area sensor; and
a determination process for deciding an error and a frequency of the error from the image information and determining an inspection result of the filament yarn on the basis of a threshold value according to the error.
